(19) United States
(12) Patent Application Publication
(10) Pub. No.: US 2024/0338932 A1
(43) Pub. Date: Oct. 10, 2024

(54) SYSTEMS, METHODS, AND APPARATUSES FOR FOUNDATION MODELS LEARNED FROM ANATOMY IN MEDICAL IMAGING VIA SELF-SUPERVISION

(71) Applicant: Arizona Board of Regents on behalf of Arizona State University, Scottsdale, AZ (US)

(72) Inventors: Mohammad Reza Hosseinzadeh Taher, Tempe, AZ (US); Jianming Liang, Scottsdale, AZ (US)

(21) Appl. No.: 18/627,810

(22) Filed: Apr. 5, 2024

Related U.S. Application Data
(60) Provisional application No. 63/457,645, filed on Apr. 6, 2023.

(51) Int. Cl. G06V 10/774; G06V 10/26; G06V 10/82

(52) U.S. Cl. CPC G06V 10/774; G06V 10/26; G06V 10/82; G06V 2201/03

(57) ABSTRACT

A self-supervised learning (SSL) model that learns from human anatomy in a plurality of medical images. A system receives a plurality of medical images and selects one for processing, including dividing the human anatomy in the selected medical image into a plurality of parts via an Anatomy Decomposer (AD) module. The AD module receives the selected medical image, generates a random anchor instance that represents a selected one of a plurality of parts of the selected medical image, and generates embedding vectors based the random anchor instance. In on embodiment, the AD module augments the random anchor instance to obtain two views of the selected part, which are passed to a respective pair of encoders that generate a respective embedding vector based thereon.

### CLAIM OF PRIORITY

This application claims the benefit of U.S. Provisional Patent Application No. 63/457,645, filed Apr. 6, 2023, entitled “SYSTEMS, METHODS, AND APPARATUSES FOR IMPLEMENTING AI MODEL LEARNING FROM ANATOMY IN CHEST RADIOGRAPH MEDICAL IMAGES FOR USE WITH MEDICAL IMAGE CLASSIFICATION AND SEGMENTATION TASKS”, the disclosure of which is incorporated by reference herein in its entirety. This application is related to U.S. Nonprovisional patent application Ser. No. 18/528,675, filed Dec. 4, 2023, entitled “SYSTEMS, METHODS, AND APPARATUSES FOR LEARNING FOUNDATION MODELS FROM ANATOMY IN MEDICAL IMAGING FOR USE WITH MEDICAL IMAGE CLASSIFICATION AND SEGMENTATION”.

### GOVERNMENT RIGHTS AND GOVERNMENT AGENCY SUPPORT NOTICE

This invention was made with government support under R01 HL128785 awarded by the National Institutes of Health. The government has certain rights in the invention.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

Embodiments of the invention relate generally to the field of medical imaging and analysis using convolutional neural networks and transformers for the classification, segmentation, and annotation of medical images, and more particularly, to systems, methods, and apparatuses for implementing foundation models learned from anatomy in medical imaging via self-supervision.

### BACKGROUND

The subject matter discussed in the background section should not be assumed to be prior art merely because of its mention in the background section. Similarly, a problem mentioned in the background section or associated with the subject matter of the background section should not be assumed to have been previously recognized in the prior art. The subject matter in the background section merely represents different approaches, which in and of themselves may also correspond to embodiments of the claimed inventions.

Machine learning models have various applications to automatically process inputs and produce outputs considering situational factors and learned information to improve output quality. One area where machine learning models, and neural networks in particular, provide high utility is in the field of processing medical images.

Within the context of machine learning and deep learning specifically, a Convolutional Neural Network (CNN, or ConvNet) is a class of deep neural networks, very often applied to analyzing visual imagery. Convolutional Neural Networks are regularized versions of multilayer perceptrons. Multilayer perceptrons are fully connected networks, such that each neuron in one layer is connected to all neurons in the next layer, a characteristic which often leads to a problem of overfitting of the data and the need for model regularization. Convolutional Neural Networks also seek to apply model regularization, but with a distinct approach. Specifically, CNNs take advantage of the hierarchical pattern in data and assemble more complex patterns using smaller and simpler patterns. Consequently, on the scale of connectedness and complexity, CNNs are on the lower extreme.

Unfortunately, prior known techniques, including prior known self-supervised methodologies, fail to provide any mechanism by which to adequately and systematically provide both classification and downstream segmentation tasks in the manner set forth herein, much less decompose human anatomy into parts via an Anatomy Decomposer (AD) module or provide removal of false negatives via a Purposive Pruner (PP) module.

What is needed is an improved architecture capable of receiving medical images, decomposing the human anatomy represented therein, and enhancing the results of the decomposition through the removal of false negatives which will degrade AI training signals.

The present state of the art may therefore benefit from the systems, methods, and apparatuses for implementing foundation model learning from anatomy in medical images via self-supervision for use with medical image classification and segmentation tasks, as is described herein.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1 illustrates an anatomy of human lungs;

FIG. 2 illustrates embodiments of a foundation model that transform pixels in an image of into semantics-rich numerical vectors, referred to as embeddings or embedding vectors;

FIG. 3 depicts embodiments that preserve locality and compositionality properties, which are intrinsic to anatomical structures and critical for understanding anatomy, in its embedding space;

FIG. 4 depicts that embodiments are capable of generating semantics-rich dense embeddings (Eve), where different anatomical structures are associated with different embeddings, and the same anatomical structures have identical or nearly identical embeddings at all resolutions and scales;

FIG. 5 depict anatomical similarity of medical images generated from a particular imaging protocol yields consistent hierarchical anatomical structures, which can be placed at different spatial locations across images due to inter-subject variations, according to embodiments;

FIG. 6 depicts an SSL strategy according to embodiments of the invention;

FIG. 7 graphically depicts superior performance of embodiments of the invention over fully/self-supervised methods;

FIG. 8A depicts ablation studies on (1) Eve's accuracy in anatomy understanding, (2) effect of anatomy decomposer;

FIG. 8B depicts ablation studies on (3) Eve's effect of purposive pruner, and (4) adaptability of novel framework to other imaging modalities, according to embodiments;

FIG. 9 depicts visualization of dense correspondence provided by Eve across different views of the same image (first row) and different patients with diversity in intensity distribution and organs' appearance (second row), in accordance with embodiments;

FIG. 10 depicts visualization of Grad-CAM heatmaps generated in accordance with embodiments of the invention (Adam) and the best performing SSL methods for eight diseases in ChestX-ray14; and

FIG. 11 depicts the performance of embodiments of the invention (Adam) on three downstream tasks under different pruning thresholds.

### DETAILED DESCRIPTION

Described herein are systems, methods, and apparatuses for implementing foundation models learned from anatomy in medical images for use with medical image classification and segmentation tasks, in the context of medical image analysis.

Notably, the novel methodologies as set forth herein are not limited to only classification tasks, but rather, the methodologies described result in a pre-trained model which has been evaluated against and successfully utilized in both chest X-ray classification as well as downstream segmentation tasks with superior results when compared with prior known techniques.

### INTRODUCTION

Human anatomy in medical imaging involves a particular characteristic: its hierarchy in nature, exhibiting two intrinsic properties: (1) locality: each anatomical structure is morphologically distinct from the others; and (2) compositionality: each anatomical structure is an integrated part of a larger whole. Embodiments envision a foundation model for medical imaging that is consciously and purposefully developed upon this foundation to gain the capability of “understanding” human anatomy and to possess the fundamental properties of medical imaging. As a first step in realizing this vision towards foundation models in medical imaging, embodiments comprise a novel self-supervised learning (SSL) strategy that exploits the hierarchical nature of human anatomy. Extensive experiments in connection with embodiments of the invention demonstrate that an SSL pretrained model, derived from a training strategy in accordance with the embodiments, not only outperforms state-of-the-art (SOTA) fully/self-supervised baselines but also enhances annotation efficiency, offering potential few-shot segmentation capabilities with performance improvements ranging from 9% to 30% for segmentation tasks compared to SSL baselines. This performance is attributed to the significance of anatomy comprehension via the learning strategy, which encapsulates the intrinsic attributes of anatomical structures—locality and compositionality—within the embedding space yet overlooked in existing SSL methods.

### 1. Introduction and Related Works

Foundation models, such as GPT-4 and DALL⊇E, pretrained via self-supervised learning (SSL), have revolutionized natural language processing (NLP) and radically transformed vision-language modeling, garnering significant public media attention. But, despite the development of numerous SSL methods in medical imaging, their success in this domain lags their NLP counterparts. It is thought that this is because the SSL methods developed for NLP have proven to be powerful in capturing the underlying structures (foundation) of the English language; thus, several intrinsic properties of the language emerge naturally, while the existing SSL methods lack such capabilities to appreciate the foundation of medical imaging—human anatomy. Therefore, what is needed are SSL methods that have the capabilities to learn foundation models from human anatomy in medical imaging.

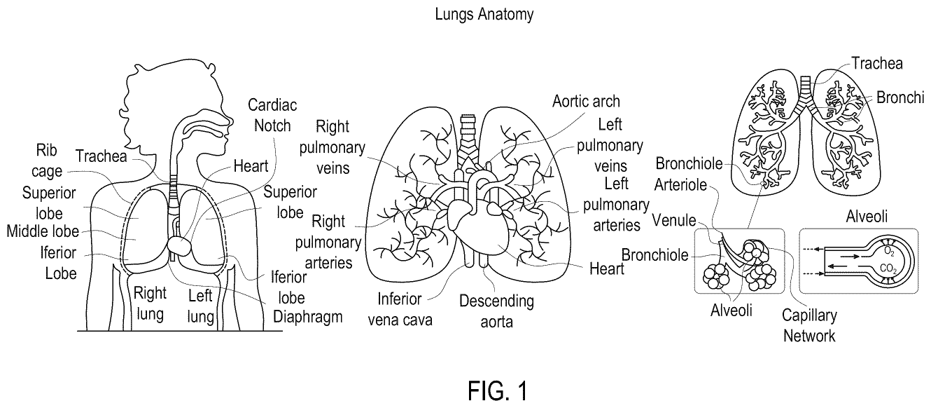

Human anatomy exhibits natural hierarchies. For example, with reference to FIG. 1, the lungs are divided into a right lung and a left lung. Each lung is further divided into lobes, two in the left lung and three in the right lung. Each lobe is further subdivided into segments, each containing pulmonary arteries, veins, and bronchi which branch in predictable, dichotomous fashion. Consequently, anatomical structures have two important properties: locality, in which each anatomical structure is morphologically distinct from others; and compositionality, in which each anatomical structure is an integrated part of a larger whole. Naturally, what is needed is a way to exploit the anatomical hierarchies for training foundation models. To this end, example embodiments comprise a novel SSL training strategy that is hierarchical, autodidactic, and coarse, resulting in a pretrained model that is versatile, and leading to anatomical embedding that is dense and semantics-meaningful. The training strategy is hierarchical because it decomposes and perceives the anatomy progressively in a coarse-to-fine manner as further described below in section 2.1; is autodidactic because it learns from anatomy through self-supervision, thereby requiring no anatomy labeling as further described below in section 2; and coarse because it generates dense anatomical embeddings without relying on pixel-level training as further described below in section 3 under the heading Ablation 1. The pretrained model is versatile because it is strong in generality and adaptability, resulting in performance boosts (see section 3.1 below) and annotation efficiency (see section 3.2 below) in a myriad of tasks. The generated anatomical embedding is dense and semantics-rich because it possesses two intrinsic properties of anatomical structures, locality (see section 3.3 below) and compositionality (see section 3.4 below), in the embedding space, both of which are essential for anatomy understanding. Embodiments of the pretrained model are referred to herein as ADAM or Adam (autodidactic dense anatomical models) because it learns autodidactically and yields a dense anatomical embedding, referred to herein as EVE or Eve (embedding vectors) for semantic richness.

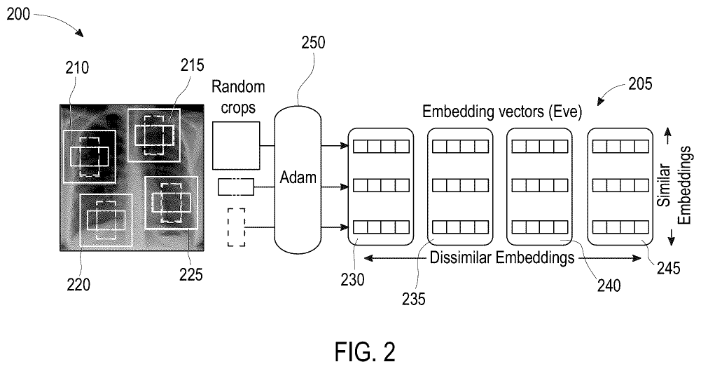

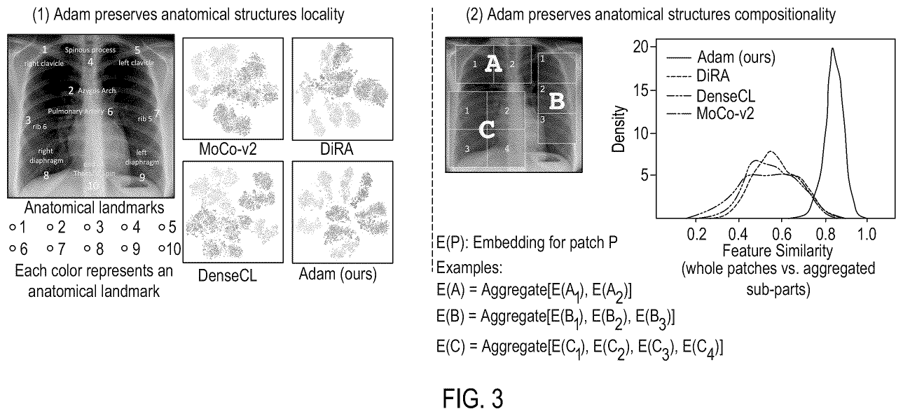

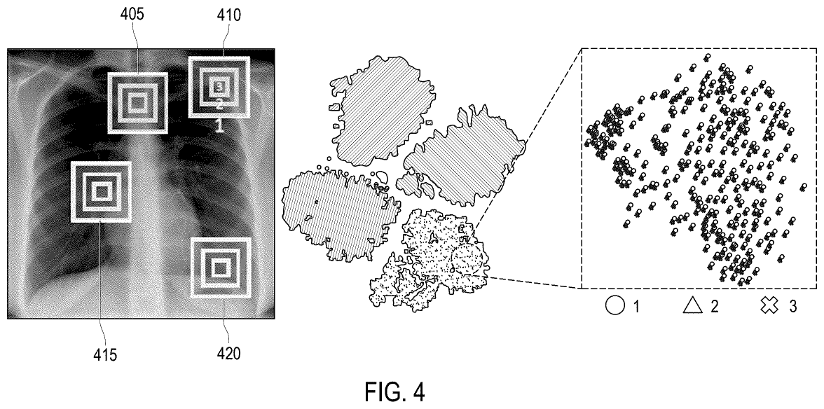

Existing SSL methods lack capabilities of “understanding” the basis of medical imaging—human anatomy. With reference to FIG. 2, embodiments of a foundation model should be able to transform at ADAM 250 each pixel in an image (e.g., a chest X-ray 200) into semantics-rich numerical vectors, called embeddings 205, where different anatomical structures 210, 215, 220 and 225 in the X-ray are respectively associated with different embeddings 230, 235, 240 and 245. Moreover, the same anatomical structures have (nearly) identical embeddings at all resolutions and scales (indicated by different box shapes at 210, 215, 220 and 225) across patients. Inspired by the hierarchical nature of human anatomy (FIG. 1), embodiments comprise a novel SSL strategy to learn anatomy from medical images (FIG. 2), resulting in embeddings (Eve), generated by embodiments of the pretrained model (Adam), with such desired properties illustrated in FIGS. 3 and 4.

In summary, embodiments described herein make the following contributions: (1) a novel self-supervised learning strategy that progressively learns anatomy in a coarse-to-fine manner via hierarchical contrastive learning; and (2) a new evaluation approach that facilitates analyzing the interpretability of deep models in anatomy understanding by measuring the locality and compositionality of anatomical structures in embedding space. Further described herein is a comprehensive and insightful set of experiments that evaluate Adam for a wide range of nine target tasks, involving fine-tuning, few-shot learning, and investigating semantic richness of Eve in anatomy understanding.

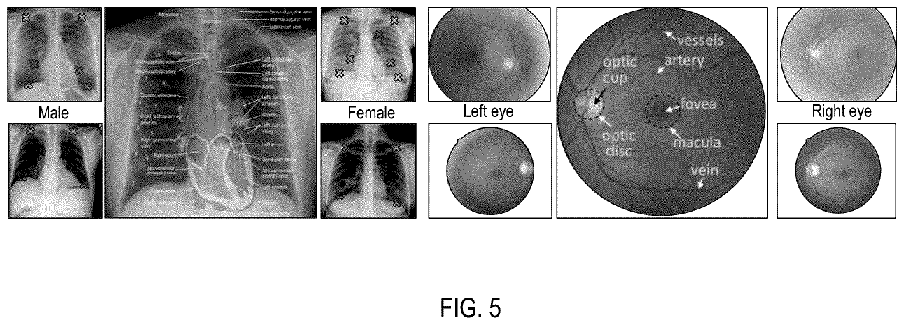

Related works: (i) self-supervised learning methods, particularly contrastive techniques, have shown great promise in medical imaging. But, due to their focus on image-level features, they are sub-optimal for dense recognition tasks. Recent works empower contrastive learning with more discriminative features via using the diversity in the local context of medical images. In contrast to these works, which overlook anatomy hierarchies in their learning objectives, Adam exploits the hierarchical nature of anatomy to learn semantics-rich dense features. (ii) anatomy learning methods integrate anatomical cues into their SSL objectives. But at least one prior art learning method requires spatial correspondence across images, limiting its scalability to non-aligned images. Although other prior art learning methods relax this requirement, they neglect hierarchical anatomy relations, offering no compositionality. By contrast, Adam learns consistent anatomy features without relying on spatial alignment across images and captures both local and global contexts hierarchically to offer both locality and compositionality (see, for example, FIG. 5 in which the anatomical similarity of medical images generated from a particular imaging protocol yields consistent hierarchical anatomical structures, which can be placed at different spatial locations across images due to inter-subject variations. Embodiments exploit the intrinsic anatomical hierarchies in medical images for SSL, yielding consistent anatomical embeddings without relying on spatial correspondence across patients). (iii) Hierarchical SSL methods exploit transformers' self-attention to model dependencies among image patches. But they fail to capture anatomy relations due to inefficient SSL signals that contrast similar anatomical structures or disregard relations among images. Adam goes beyond architecture design by introducing a learning strategy that decomposes anatomy into a hierarchy of parts for coarse-to-fine anatomy learning and avoids semantic collision in its supervision signal.

### 2. Method

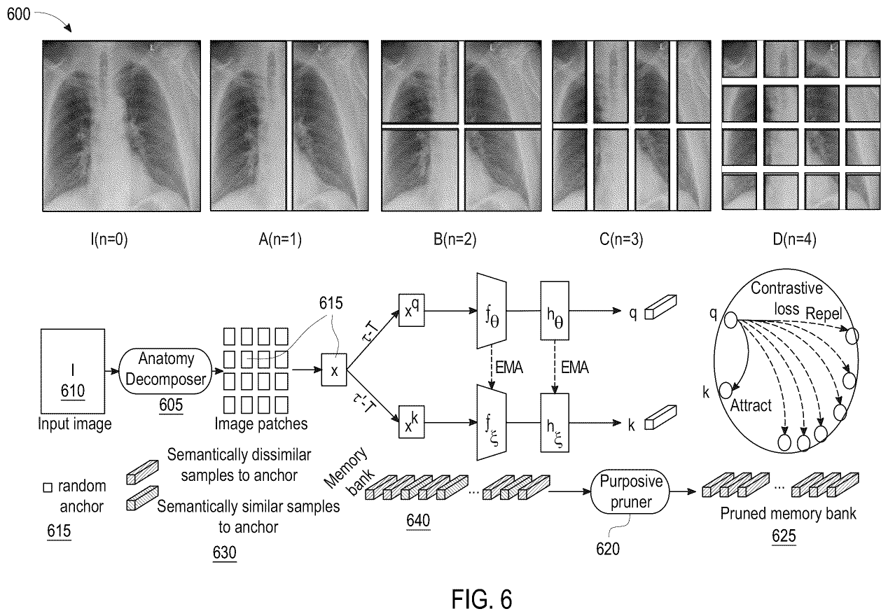

A self-supervised learning strategy, according to example embodiments, and as depicted at 600 in FIG. 6, aims to exploit the hierarchical nature of human anatomy to capture not only generic but also semantically meaningful representations. The SSL strategy gradually decomposes and perceives the anatomy in a coarse-to-fine manner. An Anatomy Decomposer (AD) decomposes the anatomy into a hierarchy of parts with granularity level n∈{0, 1, . . . } at each training stage. Thus, anatomical structures of finer-grained granularity are incrementally presented to the model as the input. An image I 610 is passed to the AD 605 to get a random anchor x 615, which is then augmented to generate two views (positive samples, i.e., two positive samples t˜T and t′˜T) and passed to two encoders to get their features (i.e., embedding vectors q and k). To avoid semantic collision in training objective, a Purposive Pruner component or module 620 removes semantically similar anatomical structures across images to anchor x (i.e., samples or views that are semantically similar to the anchor) from the memory bank 640, and stores the remaining, dissimilar anatomical structures across images to anchor x (i.e., samples or views that are semantically dissimilar to the anchor) in pruned memory bank 625. Contrastive loss is then calculated using positive samples' features and the pruned memory bank. FIG. 6 shows pretraining at n=4.

The main intuition behind the learning strategy is the principle of totality in Gestalt psychology: humans commonly first recognize the prominent objects in an image (e.g., lungs) and then gradually recognize smaller details based on prior knowledge about that object (e.g., each lung is divided into lobes). According to this principle, embodiments comprise a training strategy that decomposes and perceives the anatomy progressively in a coarse-to-fine manner, aiming to learn both anatomical (local and global) contextual information and the relative hierarchical relationships among anatomical structures. The novel framework is comprised of two key components:

Anatomy Decomposer (AD) 605 is responsible for decomposing relevant anatomy into a hierarchy of anatomical structures to guide the model to learn hierarchical anatomical relationships in images 610. The AD component 605 takes two inputs: an image I 610 and an anatomy granularity level n at each training stage and generates a random anatomical structure instance x 615. Embodiments generate anatomical structures at a desired granularity level n in a recursive manner. Given an image I, embodiments first split it vertically into two halves (A in FIG. 6). Then, embodiments iteratively alternate between horizontally and vertically splitting the resulting image parts until the desired granularity level (B, C, D in FIG. 6) is reached. This process results in 2ⁿ image patches {xᵢ}ᵢ₌₁²^{ⁿ}. In this set, the instance x is randomly sampled and used as the input for training the model. As such, during the pretraining, anatomical structures at various granular levels are generated and present to the model.

Purposive Pruner (PP) 620 is responsible for compelling the model to comprehend anatomy more effectively via learning a wider range of distinct anatomical structures. Intuitively, similar anatomical structures (e.g., ribs or intervertebral disks) should have similar embeddings, while also their finer-grained constituent parts (e.g., different ribs or disks) have different or slightly different embeddings. To achieve such desired embedding space, the anatomical structures should be intelligently contrasted from each other. The PP module 620, in contrast to standard contrastive learning approaches, identifies semantically similar anatomical structures in the embedding space and prevents them from being undesirably repelled. In particular, given an anchor anatomical structure x randomly sampled from image I, embodiments compute the cosine similarities between features of x and the ones of the points in the memory bank 640, and remove the samples with a similarity greater than a threshold γ from the memory bank. Thus, the PP 620 prevents semantic collision, yielding a more optimal embedding space where similar anatomical structures are grouped together while distinguished from dissimilar anatomical structures.

Overall training. The framework according to embodiments consists of two twin backbones ƒ_{θ} and ƒ_{ξ}, and projection heads h_{θ} and h_{ξ}. ƒ_{θ} and h_{θ} are updated by back-propagation, while ƒ_{ξ} and h_{ξ} are updated by exponential moving average (EMA) of ƒ_{θ} and h_{θ} parameters, respectively. A memory bank 640 is used to store the embeddings of negative samples MB={k₁}ᵢ₌₁^{K}, where K is the memory bank size. For learning anatomy in a coarse-to-fine manner, embodiments progressively increase the anatomical structures granularity. Thus, at each training stage, anatomical structures with granularity level n∈{0, 1, . . . } will be presented to the model. Input image I and data granularity level n are passed to the AD 605 to get a random anatomical structure x 615. An augmentation function T (·) is applied on x to generate two views x_{q} and xₖ, which are then processed by the backbones and projection heads to generate latent features q=h_{θ}(ƒ_{θ}(x_{q})) and k=h_{ξ}(ƒ_{ξ}(xₖ)). Then, q and MB is passed to the PP to remove false negative samples for anchor x, resulting in pruned memory bank 625 (MB_{pruned}), which is used to compute the loss:

$$ℒ = - log \frac{exp ( q \cdot k / τ ) \text{?}}{exp ( q \cdot k / τ ) + \text{?} exp ( q \cdot \text{?} / τ )} \text{?}$$

$$\text{?} \text{indicates text missing or illegible when filed}$$

where τ is a temperature hyperparameter, K′ is a size of MB_{pruned}, and kᵢ∈MB_{pruned}. The AD module enables the model to first learn anatomy at a coarser-grained level, and then use this acquired knowledge as effective contextual clues for learning more fine-grained anatomical structures, reflecting anatomical structures compositionality in its embedding space. The PP module enables the model to learn a semantically-structured embedding space that preserves anatomical structures locality by removing semantic collision from the model's learning objective. The pretrained model derived by the training strategy (Adam) can not only be used as a basis for myriad target tasks via adaptation (fine-tuning), but also its embedding vectors (Eve) can be used standalone without adaptation for other tasks like landmark detection.

Thus, embodiments contemplate a system comprising a memory to store instructions, a processor to execute the instructions stored in the memory, wherein the system executes the instructions to implement a self-supervised learning (SSL) model that learns from human anatomy in a plurality of medical images. The learning process includes receiving the plurality of medical images at the system, selecting one of the plurality of medical images, and dividing the human anatomy in the selected medical image into a plurality of parts via an Anatomy Decomposer (AD) module. The AD module receives as an input the selected medical image, generates a random anchor instance that represents a selected one of a plurality of parts of the selected medical image, and generates embedding vectors based on the random anchor instance.

According to some embodiments, the AD module generating embedding vectors based on the random anchor instance comprises the AD module augmenting the random anchor instance to obtain two views of the selected part, and receiving at two encoders a respective one of the two views and generating a respective embedding vector based thereon.

According to some embodiments, the AD module augmenting the random anchor instance to obtain two views of the selected part comprises the AD module augmenting the random anchor instance to obtain two positive samples of the selected part.

Some embodiments include a purposive pruner that removes views that are semantically similar to the random anchor instance, leaving only views that are semantically dissimilar to the random anchor. Such embodiments may further involve the system calculating a contrastive loss based on the embedding vectors and the views that are semantically dissimilar to the random anchor.

According to embodiments wherein the purposive pruner removes views that are semantically similar to the random anchor instance, leaving only views that are semantically dissimilar to the random anchor, a purposive pruner can remove views with a semantic similarity to the random anchor instance greater than a threshold, leaving only views that are semantically dissimilar to the random anchor instance.

According to embodiments, the system can embed the divided human anatomy comprising the views that are semantically dissimilar to the random anchor into SSL model training signals and provide the SSL training signals to a user device.

In the above embodiments, the AD module generating a random anchor instance that represents a selected one of a plurality of parts of the selected medical image can involve the AD module generating a random anchor instance that represents a selected one of a plurality of anatomical structures present in the selected medical image.

### 3. Experiments and Results

Pretraining and fine-tuning settings: some embodiments use unlabeled training images of ChestX-ray14 based on Wang, X., Peng, Y., Lu, L., Lu, Z., Bagheri, M., et al., Chestx-ray8: Hospital-scale chest x-ray database and benchmarks on weakly-supervised classification and localization of common thorax diseases, Proceedings of the IEEE/CVF Conference on Computer Vision and Pattern Recognition (CVPR), pp. 2097-2106 (2017) and EyePACS from Cuadros, J., Bresnick, G., Eyepacs, An adaptable telemedicine system for diabetic retinopathy screening, Diabetes Science and Technology 3 (3), 509-516 (2009) for pretraining and follow Chen, X., Fan, H., Girshick, R., He, K., Improved baselines with momentum contrastive learning (2020) in pretraining settings: SGD optimizer with an initial learning rate of 0.03, weight decay 1e-4, SGD momentum 0.9, cosine decaying scheduler, and batch size 256. The input anatomical structures are resized to 224×224; augmentations include random crop, color jitter, Gaussian blur, and rotation. A data granularity level (n) up to 4 is used and a pruning threshold γ=0.8 (see the ablation study on pruning threshold in section 5.3 below). Embodiments adopt ResNet-50 as the backbone. For fine-tuning, embodiments (1) use the pretrained encoder followed by a task-specific head for classification tasks, and a U-Net network for segmentation tasks where the encoder is initialized with the pretrained backbone; (2) fine-tune all downstream model's params; (3) run each method ten times on each task and report statistical significance analysis.

Downstream tasks and baselines: the experiments evaluate Adam on a myriad of nine tasks on ChestX-ray14, Shenzhen, VinDr-CXR, VinDR-Rib, SIIM-ACR, SCR, ChestX-Det, and DRIVE, covering various challenging tasks, diseases, and organs. Experiments compare Adam with SOTA image-(MoCo-v2), patch-(TransVW, VICRegL, DenseCL), and pixel-level (PCRL, DiRA, Medical-MAE, SimMIM) SSL methods.

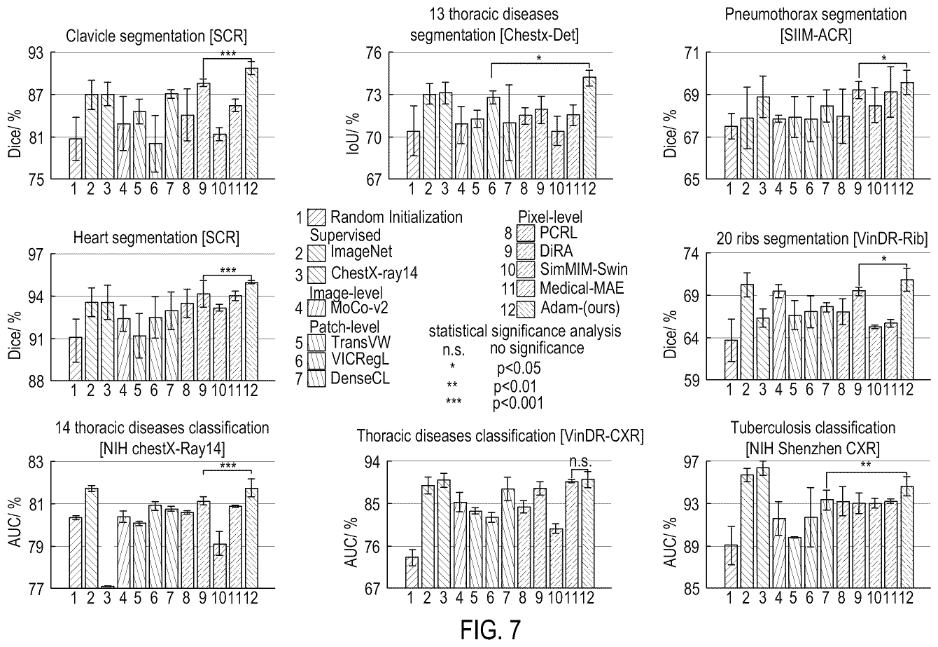

1) Adam provides generalizable representations for a variety of tasks. To showcase the significance of anatomy learning via the SSL approach used in embodiments of the invention and its impact on representation learning, transfer learning performance of Adam is compared to eight recent SOTA SSL methods with diverse objectives, as well as two fully-supervised models pretrained on ImageNet and ChestX-ray14 datasets, in eight downstream tasks. FIG. 7 graphically illustrates that embodiments provide superior performance over fully/self-supervised methods. All SSL methods are pretrained on ChestX-ray14 dataset. Statistical significance analysis (p<0.05) was conducted between Adam and the top SSL baseline in each task. As seen in FIG. 7, (i) Adam consistently outperforms the SOTA dense SSL methods (VICRegL & DenseCL) as well as the SOTA medical SSL methods (PCRL & DiRA), and achieves superior or comparable performance compared to fully-supervised baselines; (ii) Adam demonstrates a significant performance improvement over TransVW, which is specifically designed for learning recurring anatomical structures across patients. This emphasizes the effectiveness of the coarse-to-fine approach of the embodiments disclosed herein for capturing both local and global context of anatomical structures hierarchically, in contrast to Trans VW which learns them at a fixed level; and (iii) Adam remains superior to ViT-based SSL methods such as Medical-MAE and SimMIM, which divide the input image into smaller patches and utilize self-attention to model patch dependencies. This underscores the importance of the learning strategy according to the embodiments in effectively modeling the hierarchical relationships among anatomical structures.

2) Adam enhances annotation efficiency, revealing promise for few-shot learning. To dissect robustness of our representations, Adam is compared with top-performing SSL methods from each baseline group, based on FIG. 7, in limited data regimes. Experiments were conducted on Heart and Clavicle segmentation tasks, and the pretrained models fine-tuned using a few shots of labeled data (3, 6, 12, and 24) randomly sampled from each dataset. As seen in Table 1 below, Adam not only demonstrates superior performance against baselines by a large margin (see last row of Table 1) but also maintains consistent behavior with minimal performance drop as labeled data decreases, compared to baselines.

| | SCR-Heart [Dice(%)] | | | | SCR-Clavicle [Dice(%)] | | | |
|---|---|---|---|---|---|---|---|---|
| Method | 3-shot | 6-shot | 12-shot | 24-shot | 3-shot | 6-shot | 12-shot | 24-shot |
| MoCo-v2 | 44.84 | 59.97 | 69.90 | 79.69 | 23.77 | 29.24 | 38.07 | 44.47 |
| DenseCL | 64.88 | 74.43 | 75.79 | 80.06 | 36.43 | 51.31 | 63.03 | 69.13 |
| DiRA | 63.76 | 64.47 | 76.10 | 81.42 | 31.42 | 38.59 | 66.81 | 73.06 |
| Adam (ours) | 84.35 | 86.70 | 89.79 | 90.45 | 66.69 | 79.41 | 88.96 | 84.76 |
| | (↑19) | (↑12) | (↑14) | (↑9) | (↑30) | (↑28) | (↑17) | (↑12) |

Adam's superior representations over baselines, as seen in FIG. 7 and Table 1, is attributed to its ability to learn the anatomy by preserving locality and compositionality of anatomical structures in its embedding space, as is exemplified in the following.

3) Adam preserves anatomical structures locality. Adam's ability to reflect locality of anatomical structures in its embedding space against existing SSL baselines was investigated. To do so, the following steps were taken: (1) create a dataset of 1,000 images (from ChestX-ray14 dataset) with ten distinct anatomical landmarks manually annotated by human experts in each image, (2) extract 224×224 patches around each landmark across images, (3) extract latent features of each landmark instance using each pretrained model under study and then pass them through a global average pooling layer, and (4) visualize the features by using t-SNE. As seen in FIG. 3, part (1), existing SSL methods lack the ability in discriminating different anatomical structures, causing ambiguous embedding spaces. In contrast, Adam excels in distinguishing various anatomical landmarks, yielding well-separated clusters in its embedding space. This highlights Adam's ability to learn a rich semantic embedding space where distinct anatomical structures have unique embeddings, and identical structures share near-identical embeddings across patients.

4) Adam preserves anatomical structures compositionality. The embedding of a whole should be equal or close to the sum of the embedding of its each part (see E(P) examples in FIG. 3, part (2). To investigate Adam's ability to reflect compositionality of anatomical structures in its embedding space against existing SSL baselines, (1) random patches were extracted from test images of ChestX-ray14, and each patch decomposed into 2, 3, or 4 non-overlapping sub-patches, (2) each extracted patch and its sub-patches was resized to 224×224 and then their features extracted using each pretrained model under study, (3) cosine similarity was then computed between the embedding of each patch and the aggregate of the embeddings of its sub-patches, and (4) the similarity distributions were visualized with Gaussian kernel density estimation (KDE). As seen in FIG. 3, part (2), Adam's distribution is not only narrower and taller than baselines, but also the mean of similarity value between embedding of whole patches and their aggregated sub-parts is closer to 1.

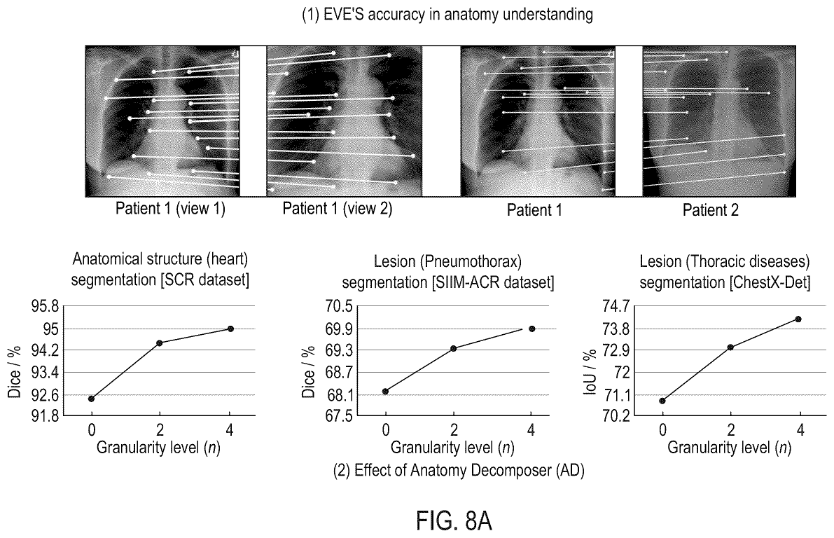

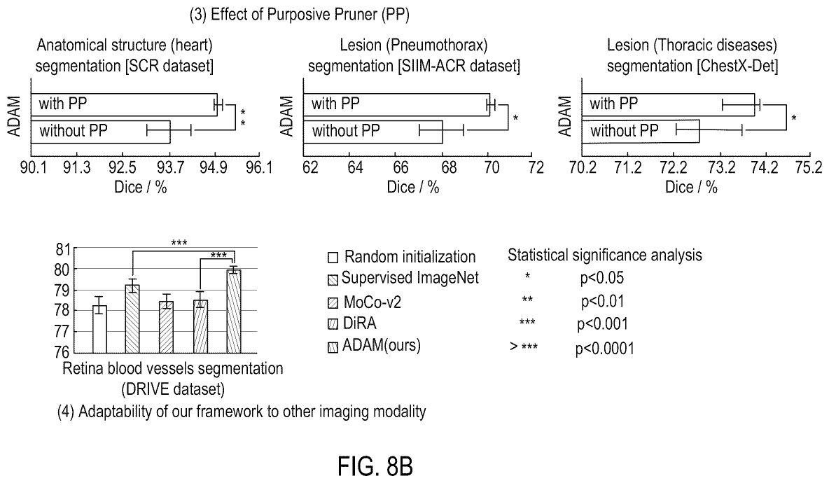

Ablation 1: Eve's accuracy in anatomy understanding was studied by visualizing dense correspondence between (i) an image and its augmented views and (ii) different images. Two given images were divided into grids of patches and their features, Eve1 and Eve2, were extracted using Adam's pretrained model. For each feature vector in Eve1, a correspondence in Eve2 was found based on highest cosine similarity; for clarity, some of the high-similarity matches (>=0.8) are shown in FIG. 8A, part (1). As seen, Eve has accurate dense anatomical representations, mapping semantically similar structures, regardless of their differences. Although Adam is not explicitly trained for this purpose, these results show its potential for landmark detection and image registration applications, as an emergent property.

Ablation 2: Effect of Anatomy Decomposer was studied by gradually increasing pretraining data granularity from coarse-grained anatomy (n=0) to finer levels (up to n=4) and fine-tuning the models on downstream tasks. As seen in FIG. 8A, part (2), gradual increment of data granularity consistently improves the performance across all tasks. This suggests that the coarse-to-fine learning strategy in accordance with the embodiments deepens the model's anatomical knowledge.

Ablation 3: Effect of Purposive Pruner (PP) was studied by comparing a model with and without PP (i.e., contrasting an anchor with all negative pairs in the memory bank) during pretraining. FIG. 8B, part (3) shows PP leads to significant performance boosts across all tasks, highlighting its key role in enabling the model to capture more discriminative features by removing noisy contrastive pairs.

Ablation 4: Adaptability of novel framework to other imaging modalities was explored by utilizing fundoscopy photography images in EyePACS as pretraining data, which possess complex structures due to the diverse variations in retinal anatomy. As depicted in FIG. 8B, part (4), Adam provides superior performance by 1.4% (p<0.05) in the blood vessel segmentation task compared to the top-performing SSL methods that also leverage the same pretraining images. This highlights the importance of effectively learning the anatomy and showcases the potential applicability of the disclosed embodiments to various imaging modalities.

### 4. Adam's Capability in Anatomy Understanding

Further, more detailed, discussion follows regarding Adam's capability to generate semantics-rich dense embeddings, where different anatomical structures are associated with different embeddings, and the same anatomical structures have (nearly) identical embeddings at all resolutions and scales. To do so, with reference to FIG. 4, a dataset comprising 1,000 images is employed along with four distinct anatomical landmarks 405, 410, 415 and 420 annotated in each image (details in section 3.3). Three patches of different resolutions are then extracted, denoted as levels 1, 2, and 3, around each landmark location across the images. As a result, instances of each of the four distinct anatomical landmarks represent different anatomical structures. Furthermore, the anatomical structures corresponding to these four landmarks at level 1 exhibit close similarity to their corresponding structures at levels 2 and 3. All anatomical structures in each level are resized to 224×224, and Adam's pretrained model is used to extract their embeddings (i.e., Eve). Finally, tSNE is used to visualize the embeddings. As seen in FIG. 4, the instances of four distinct anatomical landmarks 405, 410, 415 and 420 are well-separated from one another, highlighting Adam's capability in distinguishing different anatomical structures. Moreover, the embeddings of the anatomical structures at levels 1, 2, and 3 for each of the four landmarks are close to each other, echoing Adam's ability to provide (almost) identical embeddings for similar anatomical structures across different resolutions.

### 5. Additional Results

### 5.1. Dense Correspondence Visualization

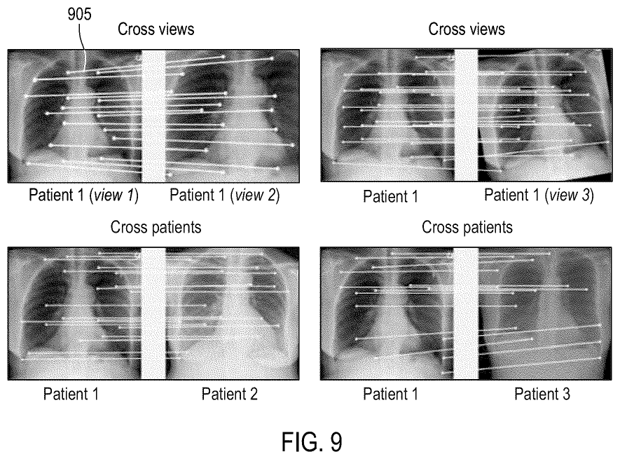

To further demonstrate Eve's accuracy in anatomy understanding, Eve's robustness is explored with respect to (i) image augmentations and (ii) variations in appearance, intensity, and texture of anatomical structures caused by inter-subject differences or data distribution shifts. To do so, dense correspondence is visualized between (i) an image and its augmented views produced by cropping and rotation (10 degrees) and (ii) images of different patients with considerable diversity in intensity distribution, texture, and organs' shape. For clarity of figures, only some of the high-similarity matches are shown. A match between two feature vectors is represented by a line, for example, line 905 in FIG. 9. The figure shows Eve can find similar anatomical patterns across the different views or even across patients. Thus, Eve provides accurate anatomical representations, mapping semantically similar anatomical structures, regardless of their subtle differences in shape, intensity, and texture, to similar embeddings. These results show the potential for landmark detection and image registration applications using embodiments of the invention.

### 5.2. GradCAM Visualizations for Disease Localization

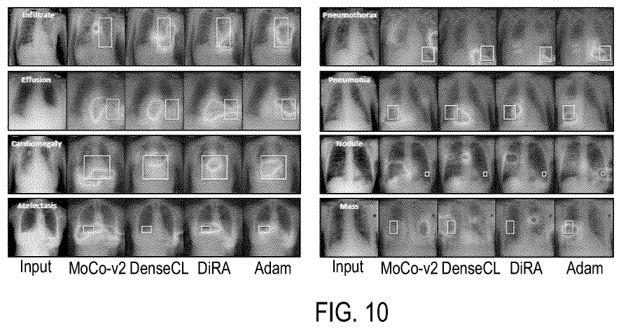

The following discussion further assess the efficacy of Adam's representations for weakly-supervised disease localization. To do so, a ChestX-ray14 dataset was used that provides bounding box annotations of eight abnormalities for around 1,000 test images. The images with bounding box annotations are only used during the testing phase to evaluate the localization accuracy. For training, the downstream model was initialized with Adam's pretrained weights and fine-tuned it using only image-level disease labels. Then, heatmaps were calculated using GradCAM to approximate the spatial location of a particular disease. Adam is compared with the best performing SSL methods from each baseline group (i.e., instance-level, patch-level, and pixel-level). FIG. 10 shows examples of GradCAM for Adam and other SSL baselines in eight thoracic diseases, including Atelectasis, Cardiomegaly, Effusion, Infiltrate, Mass, Nodule, Pneumonia, Pneumothorax. FIG. 10 depicts visualization of Grad-CAM heatmaps generated by Adam and the best performing SSL methods for eight diseases in ChestX-ray14. White boxes indicate ground truth. Adam provides more precise localization results than baselines that focus on larger image regions or fail to overlap with the ground truth. As seen, Adam captures the diseased areas more precisely than the baselines. In particular, SSL baselines' attention maps either focus on larger image regions or don't overlap with the ground truth, whereas Adam provides more robust localization results across all diseases. These findings highlight Adam's ability to learn dense representations that are more useful for disease localization.

### 5.3. Ablation Study on Pruning Threshold

To explore the impact of pruning threshold (γ) of the PP module on the performance of downstream tasks, extensive ablation studies have been conducted on different values of γ. To do so, Adam is pretrained with three pruning thresholds 0.7, 0.8, and 0.9, and the pretrained model is transferred with each pruning threshold to three downstream tasks, including SCR-Heart, SIIM-ACR, and ChestX-Det.

### 6. Algorithm 1: Purposive Pruner Algorithm

Algorithm 1 presents the details of the purposive pruner (PP) component.

Algorithm 1: Purposive Pruner

| | |
|---|---|
| Input: | Anchor embeddings q; |
| | Granularity level n; |
| | Pruning threshold γ; |
| | Memory bank MB; |

Output: Pruned memory bank MB_{pruned}

| 1 | if n = 0 then | | |
|---|---|---|---|
| 2 | \| | MB_{pruned} = MB ; | |
| 3 | else | | |
| 4 | \| | // \|remove semantically similar patches to anchor from the | |
| | | memory bank | |
| 5 | \| | $// sim ( x , y ) = \frac{x}{{‖ x ‖}_{2}} \cdot \frac{y}{{‖ y ‖}_{2}}$ | |
| 6 | \| | foreach kᵢ ∈ MB do | |
| 7 | \| | if sim(kᵢ, q) < γ then | |
| 8 | \| | \| | MB_{pruned} ← kᵢ ; |

| | | |
|---|---|---|
| 9 | \| | end |

| | |
|---|---|
| 10 | end |

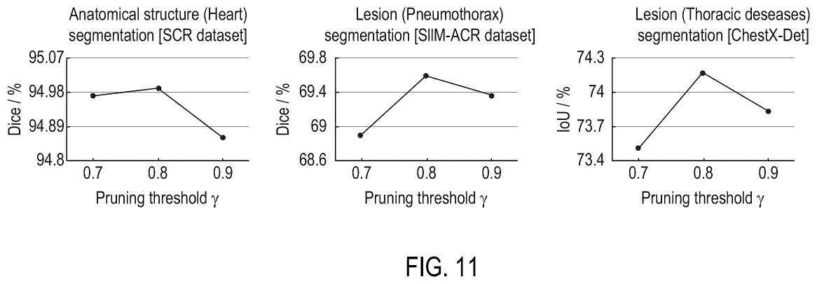

FIG. 11 depicts the performance of Adam on three downstream tasks under different pruning thresholds. The best performance achieved at γ=0.8 in all applications.

### 7. Datasets and Downstream Tasks

Adam is pretrained on two publicly available datasets, and the transfer capability of Adam's representations is thoroughly evaluated in a wide range of nine challenging downstream tasks on eight publicly available datasets in chest X-ray and fundus modalities. The following discussion provides details of datasets and downstream tasks used in the study.

(1) ChestX-ray14—multi-label classification: ChestX-ray14 dataset provides 112K chest radiographs taken from 30K unique patients, along with 14 thoracic disease labels. Each individual image may have more than one disease label. The downstream task is a multi-label classification in which the models are trained to predict 14 diseases for each image. The official patient-wise split released by the dataset is used, including 86K training images and 25K testing images. A mean AUC is used over 14 diseases to evaluate the multi-label classification performance. Moreover, the unlabeled training data is used for pretraining of Adam and other self-supervised baselines.

(2) NIH Shenzhen CXR—binary classification: NIH Shenzhen CXR dataset provides 662 frontal-view chest radiographs, among which 326 images are normal and 336 images are patients with tuberculosis (TB) disease. The downstream task is a binary classification in which the models are trained to detect TB in images. The dataset is randomly divided into a training set (80%) and a test set (20%). An AUC score is reported to evaluate the classification performance.

(3) VinDR-CXR—multi-label classification: VinDR-CXR dataset provides 18,000 posterior-anterior (PA) view chest radiographs that were manually annotated by a total of 17 experienced radiologists for the classification of five common thoracic diseases, including pulmonary embolism, lung tumor, pneumonia, tuberculosis, and other diseases. The dataset provides an official split, including a training set of 15,000 scans and a test set of 3,000 scans. The official split is used, and the AUC score report used to evaluate the classification performance.

(4) SIIM-ACR—lesion segmentation: SIIM-ACR dataset provides 10K chest radiographs, including normal cases and cases with pneumothorax disease. For diseased cases, pixel-level segmentation masks are provided. The downstream task is pneumothorax segmentation. The dataset is randomly divided into training (80%) and testing (20%). A mean Dice score is used to evaluate segmentation performance.

(5) ChestX-Det—lesion segmentation: ChestX-Det dataset consists of 3,578 images from ChestX-ray14 dataset. This dataset provides segmentation masks for 13 thoracic diseases, including atelectasis, calcification, cardiomegaly, consolidation, diffuse nodule, effusion, emphysema, fibrosis, fracture, mass, nodule, pleural thickening, and pneumothorax. The images are annotated by three board-certified radiologists. The downstream task is pixel-wise segmentation of abnormalities in images. The dataset is randomly divided into training (80%) and testing (20%). The mean IoU score is used to evaluate the segmentation performance.

(6) SCR-Heart&Clavicle—organ segmentation: SCR dataset provides 247 posterior-anterior chest radiographs from JSRT database along with segmentation masks for the heart, lungs, and clavicles. The data has been subdivided into two folds with 124 and 123 images. The official split of the dataset is followed, using fold1 for training (124 images) and fold2 for testing (123 images). The mean Dice score is used to evaluate the heart and clavicles segmentation performances.

(7) VinDR-Rib—organ segmentation: VinDR-Rib dataset contains 245 chest radiographs that were obtained from VinDr-CXR dataset and were manually labeled by human experts. The dataset provides segmentation annotations for 20 individual ribs. The official split released by the dataset is used, including a training set of 196 images and a validation set of 49 images. A mean Dice score is used to evaluate segmentation performance.

(8) EyePACS—self-supervised pretraining: EyePACS dataset consists of 88,702 color fundus images. Expert annotations for the presence of Diabetic Retinopathy (DR) with a scale of 0-4 were provided for each image. The dataset provides an official split, including 35,126 samples for training and 53,576 samples for testing. Unlabeled training images were used for self-supervised pretraining of Adam and other SSL baselines.

(9) DRIVE—organ segmentation: The Digital Retinal Images for Vessel Extraction (DRIVE) dataset includes 40 color fundus images along with expert annotations for retinal vessel segmentation. The set of 40 images was equally divided into 20 images for the training set and 20 images for the testing set. The official data split was used and the mean Dice score reported for the segmentation of blood vessels.

### 8. Implementation Details

### 8.1. Pretraining Protocol

The training strategy in accordance with embodiments of the invention uses a standard ResNet-50 as the backbone in accordance with common protocol. Any other sophisticated backbones (i.e., variants of convolutional neural networks or vision transformers) can, however, be leveraged in our proposed training strategy. In this study, the aim was to dissect the importance of training strategy in blazing the way for learning generalizable representations. As such, other confounding factors are controlled, including the pretraining data. Consequently, Adam and all self-supervised baseline methods are pretrained on the same pretraining data from ChestX-ray14 and EyePACS datasets. The settings of Chen, X., Fan, H., Girshick, R., He, K., Improved baselines with momentum contrastive learning (2020) were closely followed for the training parameters, including the architecture of projection heads (i.e., two-layer MLP), memory bank size (i.e., K=65536), contrastive temperature scaling (i.e., ⊖=0.2), and momentum coefficient (0.999). Even values are used for n and the training process is continued up to n=4, but one can continue the training process with finer data granularity levels. It should be noted that the PP module imposes a negligible computational cost to the pretraining stage. A batch size of 256 was used, distributed across four Nvidia V100 GPUs with a memory of 32 GB per-card. At each training stage n, the model is trained for 200 epochs.

### 8.2. Fine-Tuning Protocol

Adam's pretrained backbone (i.e., ƒ_{θ}) is transferred to the downstream classification tasks by appending a task-specific classification head. For the downstream segmentation tasks, a U-Net network is employed with a ResNet-50 encoder, where the encoder is initialized with the pre-trained backbone. Following the standard protocol, the generalization of Adam's representations is evaluated by fine-tuning all the parameters of downstream models. An input image resolution of 224×224 and 512×512 is used for downstream tasks on chest X-ray and fundus images, respectively. Each downstream task is optimized with the best-performing hyperparameters as follows. For downstream classification tasks, standard data augmentation techniques are used, including random rotation by (−7, 7) degree, random crop, and random horizontal flip with probability 0.5. Training settings are based on Xiao, J., Bai, Y., Yuille, A., Zhou, Z., Delving into masked autoencoders for multilabel thorax disease classification, Proceedings of the IEEE/CVF Winter Conference on Applications of Computer Vision (WACV), pp. 3588-3600 (2023) including the AdamW optimizer with weight decay 0.05, β₁, β₂=(0.9, 0.95), learning rate 2.5e-4, and cosine annealing learning rate decay scheduler. For downstream segmentation tasks, standard data augmentation techniques are used, including random gamma, elastic transformation, random brightness contrast, optical distortion, and grid distortion. Adam optimizer is used with a learning rate 1e-3 for VinDR-Ribs and AdamW optimizer is used with a learning rate 2e-4 for the rest of the tasks. A cosine learning rate decay scheduler is used and early-stopping using 10% of the training data as the validation set. Each method is run times on each task and the average, standard deviation, and statistical analysis is reported based on an independent two-sample t-test.

### 9. Conclusion and Future Work

A key contribution of the disclosed embodiments lies in crafting a novel SSL strategy that underpins the development of powerful self-supervised models foundational to medical imaging via learning anatomy. The training strategy according to the embodiments progressively learns anatomy in a coarse-to-fine manner via hierarchical contrastive learning. This approach yields highly generalizable pretrained models and anatomical embeddings with essential properties of locality and compositionality, making them semantically meaningful for anatomy understanding. The strategy may also be applied to provide dense anatomical models for major imaging modalities and protocols.

In addition to various hardware components described herein, embodiments further include various operations. The operations described in accordance with such embodiments may be performed by hardware components or may be embodied in machine-executable instructions, which may be used to cause a specialized and special-purpose processor having been programmed with the instructions to perform the operations described herein. Alternatively, the operations may be performed by a combination of hardware and software. In such a way, the embodiments of the invention provide a technical solution to a technical problem.

Embodiments also relate to an apparatus for performing the operations disclosed herein. This apparatus may be specially constructed for the required purposes, or it may be a special purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

While the algorithms and displays presented herein are not inherently related to any particular computer or other apparatus, they are specially configured and implemented via customized and specialized computing hardware which is specifically adapted to more effectively execute the novel algorithms and displays. Various customizable and special purpose systems may be utilized in conjunction with specially configured programs in accordance with the teachings herein, or it may prove convenient, in certain instances, to construct a more specialized apparatus to perform the required method steps. In addition, embodiments are not described with reference to any particular programming language. It will be appreciated that a variety of programming languages may be used to implement the teachings of the embodiments as described herein.

Embodiments may be provided as a computer program product, or software, that may include a machine-readable medium having stored thereon instructions, which may be used to program a computer system (or other electronic devices) to perform a process according to the disclosed embodiments. A machine-readable medium includes any mechanism for storing or transmitting information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices, etc.), a machine (e.g., computer) readable transmission medium (electrical, optical, acoustical), etc.

Any of the disclosed embodiments may be used alone or together with one another in any combination. Although various embodiments may have been partially motivated by deficiencies with conventional techniques and approaches, some of which are described or alluded to within the specification, the embodiments need not necessarily address or solve any of these deficiencies, but rather, may address only some of the deficiencies, address none of the deficiencies, or be directed toward different deficiencies and problems which are not directly discussed.

It is appreciated that a machine in the exemplary form of a computer system, in accordance with one embodiment, includes a set of instructions that may be executed to cause the machine/computer system to perform any one or more of the methodologies discussed herein.

In alternative embodiments, the machine may be connected (e.g., networked) to other machines in a Local Area Network (LAN), an intranet, an extranet, or the public Internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set top box (STB), a Personal Digital Assistant (PDA), a cellular telephone, a web appliance, a server, a network router, switch or bridge, computing system, or any machine capable of executing a set of instructions (sequential or otherwise) that specify and mandate the specifically configured actions to be taken by that machine pursuant to stored instructions. Further, while the machine may be a single machine, the term “machine” shall also be taken to include any collection of machines (e.g., computers) that individually or jointly execute a set (or multiple sets) of instructions to perform any one or more of the methodologies discussed herein.

An exemplary computer system includes a processor, a main memory (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory (e.g., a persistent storage device including hard disk drives and a persistent database and/or a multi-tenant database implementation), which communicate with each other via a bus. Main memory includes an encoder-decoder network (e.g., such as an encoder-decoder implemented via a neural network model) for performing operations including processing medical imaging in support of the methodologies and techniques described herein. Main memory and its sub-elements are further operable in conjunction with processing logic and a processor to perform the methodologies discussed herein.

A processor represents one or more specialized and specifically configured processing devices such as a microprocessor, central processing unit, or the like. More particularly, the processor may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor may also be one or more special-purpose processing devices such as an application-specific integrated circuit (ASIC), a field programmable gate array (FPGA), a digital signal processor (DSP), network processor, or the like. The processor is configured to execute the processing logic for performing the operations and functionality discussed herein.

The computer system may further include a network interface card. The computer system also may include a user interface (such as a video display unit, a liquid crystal display, etc.), an alphanumeric input device (e.g., a keyboard), a cursor control device (e.g., a mouse), and a signal generation device (e.g., an integrated speaker). The computer system may further include peripheral device (e.g., wireless or wired communication devices, memory devices, storage devices, audio processing devices, video processing devices, etc.).

The secondary memory may include a non-transitory machine-readable storage medium or a non-transitory computer readable storage medium or a non-transitory machine-accessible storage medium on which is stored one or more sets of instructions (e.g., software) embodying any one or more of the methodologies or functions described herein. The software may also reside, completely or at least partially, within the main memory and/or within the processor during execution thereof by the computer system, the main memory and the processor also constituting machine-readable storage media. The software may further be transmitted or received over a network via the network interface card.

While the subject matter disclosed herein has been described by way of example and in terms of the specific embodiments, it is to be understood that the claimed embodiments are not limited to the explicitly enumerated embodiments disclosed. To the contrary, the disclosure is intended to cover various modifications and similar arrangements as are apparent to those skilled in the art. Therefore, the scope of the appended claims is to be accorded the broadest interpretation to encompass all such modifications and similar arrangements. It is to be understood that the above description is intended to be illustrative, and not restrictive. Many other embodiments will be apparent to those of skill in the art upon reading and understanding the above description. The scope of the disclosed subject matter is therefore to be determined in reference to the appended claims, along with the full scope of equivalents to which such claims are entitled.

What is claimed is:

1. A system comprising:
a memory to store instructions;
a processor to execute the instructions stored in the memory;
wherein the system executes the instructions to implement a self-supervised learning (SSL) model that learns from human anatomy in a plurality of medical images, comprising:
receiving the plurality of medical images at the system;
selecting one of the plurality of medical images;
dividing the human anatomy in the selected medical image into a plurality of parts via an Anatomy Decomposer (AD) module, the AD module:
receiving as an input the selected medical image;
generating a random anchor instance that represents a selected one of a plurality of parts of the selected medical image; and
generating embedding vectors based on the random anchor instance.

2. The system of claim 1, wherein the AD module generating embedding vectors based on the random anchor instance comprises the AD module:
augmenting the random anchor instance to obtain two views of the selected part; and
receiving at two encoders a respective one of the two views and generating a respective embedding vector based thereon.

3. The system of claim 2, wherein the AD module augmenting the random anchor instance to obtain two views of the selected part comprises the AD module augmenting the random anchor instance to obtain two positive samples of the selected part.

4. The system of claim 3, further comprising a purposive pruner that removes views that are semantically similar to the random anchor instance, leaving only views that are semantically dissimilar to the random anchor instance.

5. The system of claim 4, further comprising the system calculating a contrastive loss based on the embedding vectors and the views that are semantically dissimilar to the random anchor instance.

6. The system of claim 4 wherein the purposive pruner that removes views that are semantically similar to the random anchor instance, leaving only views that are semantically dissimilar to the random anchor instance, comprises a purposive pruner that removes views with a semantic similarity to the random anchor instance greater than a threshold, leaving only views that are semantically dissimilar to the random anchor instance.

7. The system of claim 6, wherein the system further embeds the divided human anatomy comprising the views that are semantically dissimilar to the random anchor instance into SSL model training signals; and
provides the SSL training signals to a user device.

8. The system of claim 1, wherein the AD module generating a random anchor instance that represents a selected one of a plurality of parts of the selected medical image comprises the AD module generating a random anchor instance that represents a selected one of a plurality of anatomical structures present in the selected medical image.

9. A computer-implemented method performed by a system having at least a processor and a memory therein to execute instructions for implementing a self-supervised learning (SSL) model that learns from anatomy in a plurality of medical images, the computer-implemented method comprising:
receiving the plurality of medical images at the system;
selecting one of the plurality of medical images;
dividing the anatomy in the selected medical image into a plurality of parts via an Anatomy Decomposer (AD) module, the AD module:
receiving as an input the selected medical image;
generating a random anchor instance that represents a selected one of a plurality of parts of the selected medical image; and
generating embedding vectors based the random anchor instance.

10. The computer-implemented method of claim 9, wherein the generating via the AD module the embedding vectors based on the random anchor instance comprises:
augmenting the random anchor instance to obtain two views of the selected part; and
receiving at two encoders a respective one of the two views and generating a respective embedding vector based thereon.

11. The computer-implemented method of claim 10, wherein the augmenting via the AD module the random anchor instance to obtain two views of the selected part comprises augmenting the random anchor instance to obtain two positive samples of the selected part.

12. The computer-implemented method of claim 11, further comprising removing views, via a purposive pruner, that are semantically similar to the random anchor instance, leaving only views that are semantically dissimilar to the random anchor instance.

13. The computer-implemented method of claim 12, further comprising calculating a contrastive loss based on the embedding vectors and the views that are semantically dissimilar to the random anchor instance.

14. The computer-implemented method of claim 12 wherein the removing the views that are semantically similar to the random anchor instance, leaving only views that are semantically dissimilar to the random anchor instances, comprises removing views with a semantic similarity to the random anchor instance greater than a threshold, leaving only views that are semantically dissimilar to the random anchor instance.

15. The computer-implemented method of claim 14, further comprising embedding the divided anatomy comprising the views that are semantically dissimilar to the random anchor into SSL model training signals; and
providing the SSL training signals to a user device.

16. The computer-implemented method of claim 9, wherein the generating the random anchor instance that represents a selected one of a plurality of parts of the selected medical image comprises generating a random anchor instance that represents a selected one of a plurality of anatomical structures present in the selected medical image.

17. A non-transitory computer readable storage media having instructions stored thereupon that, when executed by a system having at least a processor and a memory therein, implement a self-supervised learning (SSL) model that learns from anatomy in a plurality of medical images by:
receiving the plurality of medical images at the system;
selecting one of the plurality of medical images;
dividing the anatomy in the selected medical image into a plurality of parts via an Anatomy Decomposer (AD) module, the AD module:
receiving as an input the selected medical image;
generating a random anchor instance that represents a selected one of a plurality of parts of the selected medical image; and
generating embedding vectors based the random anchor instance.

18. The non-transitory computer readable storage media of claim 17, wherein the AD module generating the embedding vectors based on the random anchor instance comprises the AD module:
augmenting the random anchor instance to obtain two views of the selected part; and
receiving at two encoders a respective one of the two views and generating a respective embedding vector based thereon.

19. The non-transitory computer readable storage media of claim 18, wherein the AD module augmenting the random anchor instance to obtain two views of the selected part comprises the AD module augmenting the random anchor instance to obtain two positive samples of the selected part.

20. The non-transitory computer readable storage media of claim 19, further comprising a purposive pruner that removes views that are semantically similar to the random anchor instance, leaving only views that are semantically dissimilar to the random anchor instance.
